(19) United States
(12) Patent Application Publication
(10) Pub. No.: US 2008/0254178 A1
(43) Pub. Date: Oct. 16, 2008

(54) ICE CREAM SCOOP AND METHOD

(75) Inventors: Ralph W. Allen, Trufant, MI (US); Paige T. Allen, Trufant, MI (US)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Ralph W. Allen, Trufant, MI (US)

(21) Appl. No.: 12/102,549

(22) Filed: Apr. 14, 2008

Related U.S. Application Data
(60) Provisional application No. 60/923,413, filed on Apr. 13, 2007.

(51) Int. Cl. A23G 9/28

(52) U.S. Cl. 426/389; 425/276

(57) ABSTRACT

An ice cream scoop includes a scooping bowl and a handle coupled to the scooping bowl. The scoop defines a confection retention enclosure for receiving a candy confection therein. An aperture is provided for dispensing the confection out of the enclosure. A removable plug is used to cover the aperture to selectively permit and prevent the confection from being dispensed out of the enclosure. The retention enclosure may be transparent or translucent to permit viewing of the confection located therein.

### CROSS REFERENCE TO RELATED APPLICATION

The present invention claims the benefit of U.S. provisional application Ser. No. 60/923,413, filed Apr. 13, 2007, which is hereby incorporated herein by reference in its entirety.

### FIELD OF THE INVENTION

The present invention relates generally to frozen confection serving devices, and, more particularly, to ice cream scoops.

### BACKGROUND OF THE INVENTION

Ice cream and other frozen confections are enjoyed around the world, and are often eaten with sprinkled candy or nuts on top. Traditionally, ice cream is stored in large refrigerated receptacles and scooped into smaller portions for individual servings. Traditionally, to serve a portion of ice cream with candy or nuts on top, a portion of ice cream is first scooped into an individual serving with a scoop, and then candy and/or nuts are sprinkled over the ice cream using a spoon, an open bag, or other dispensing device.

### SUMMARY OF THE INVENTION

The present invention provides a dual function ice cream scoop that is used to perform the scooping of ice cream and is also used to perform the dispensing of candy confections, nuts, or other toppings. In one form of the present invention, the dual function scoop is provided with a hollow handle that is adapted to store candies, ground nuts, or the like. The scoop allows a user to scoop a portion of frozen confection, such as ice cream, and then sprinkle or otherwise dispense the candy out of the handle and onto the frozen confection before serving.

According to another form of the present invention, an ice cream scoop includes a scooping bowl and a handle. The handle defines a substantially hollow section to receive a topping such as a candy confection or nuts. The handle has a first end, a second end, a gripping surface, and at least one aperture. The aperture permits dispensing of the confection, and a cover is provided for covering the aperture. In one aspect of the invention, the handle is substantially clear to permit viewing of the confection inside the handle. Alternatively, the confection storing region of the device includes a viewing zone that is transparent and provides for viewing of the confection stored therein. That viewing zone or zones may be decoratively configured to increase the aesthetic appeal of the device. Still alternatively, the viewing zone or handle are translucent to allow viewing of the stored confection, and may impart other attributes such as a tinting or distortion of light reflected by the stored confections.

According to another form of the present invention, a method of serving ice cream is provided. The method includes providing an ice cream scoop having a handle defining a hollow section with a topping such as a candy confection contained inside the handle. The handle defines an aperture for dispensing the candy confection. Next, a portion of the frozen confection is scooped with the scoop, and the candy confection is dispensed through the aperture and onto the frozen confection.

These and other objects, advantages, purposes, and features of the present invention will become apparent upon review of the following specification in conjunction with the drawings.

### BRIEF DESCRIPTION OF THE DRAWINGS

FIG. 1 is a perspective view of a first embodiment of the ice cream scoop of the present invention;

FIG. 2 is another perspective view of the ice cream scoop;

FIG. 3 is a side elevation view of the ice cream scoop;

FIG. 4 is a top plan view of the ice cream scoop; and

FIG. 5 is a perspective view of the ice cream scoop, taken towards the second end as viewed from above.

### DESCRIPTION OF THE PREFERRED EMBODIMENTS

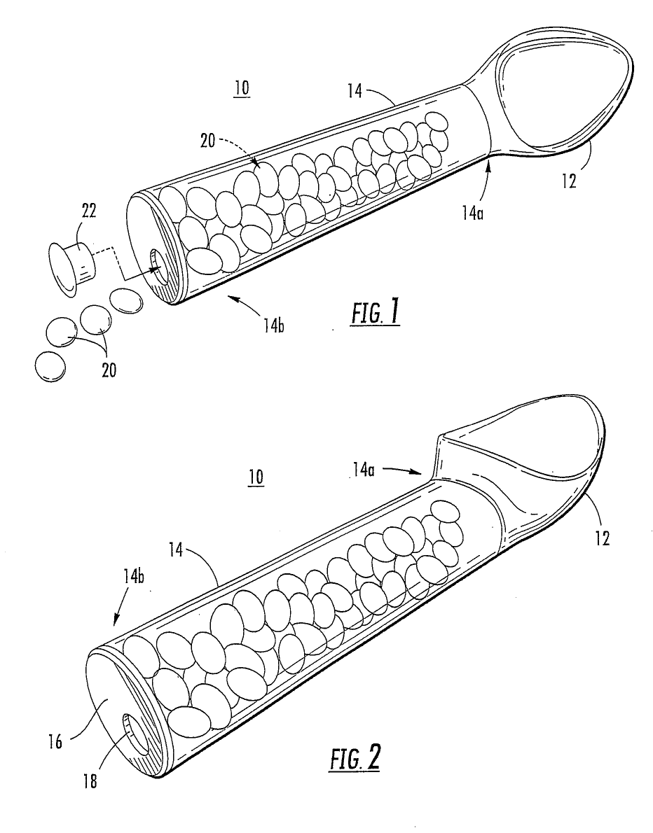

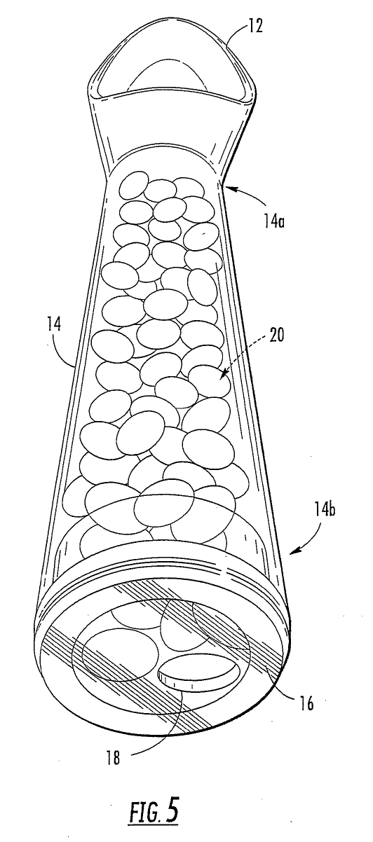

Referring now to the drawings, an ice cream scoop, one preferred form of which is referenced by the numeral 10, is provided for serving frozen confections, such as ice cream, frozen yoghurt, frozen custard, or the like, and also allows a user to store and dispense candy confections onto the frozen confection. The scoop 10 has a bowl portion 12 and a handle portion 14. Handle 14 is substantially hollow and has a first end 14a and a second end 14b. Bowl portion 12 is attached to handle 14 at first end 14a. An end cap 16 is provided at second end 14b of handle 14 (FIGS. 1-5). End cap 16 includes an aperture 18 for dispensing a topping such as a candy confection 20.

Handle 14 is a tapered hollow cylinder sized to comfortably fit in a user's hand. Handle 14 is open at second end 14b, through which candy confection may be added to handle 14. Handle 14 may incorporate dispensing holes (not shown) through the cylindrical wall, such as proximate first end 14a, proximate second end 14b, or between first end 14a and second end 14b. Handle 14 is made of clear plastic, and may be made of any suitably strong material resistant to embrittlement in low temperatures. Alternatively, for example, the handle may comprise an inner cylinder rotatably or slidably mounted within an outer cylinder, each cylinder having one or more dispensing holes that may be aligned to dispense candy, and un-aligned to prevent spillage of candy. Handle 14 may be opaque or translucent, for example, and may have a light filter to create color, reflection, refraction, and/or distortion effects on the light reflected by candy 20. Alternatively, handle 14 may have one or more viewing regions (not shown), where the viewing regions may be one or more of a plurality of shapes, for example, stars, strips, circles, triangles, lines, etc.

End cap 16 is removable and fits snugly into second end 14b of handle 14, substantially closing off the opening in handle 14 at second end 14b. End cap 16 defines aperture 18. End cap 16 may be made of plastic, rubber, or other resilient material, and may be retained in handle 14 such as with screw threads, friction fit, snap-fit, or the like. Alternatively, end cap 16 may be fixed in second end 14b of handle 14.

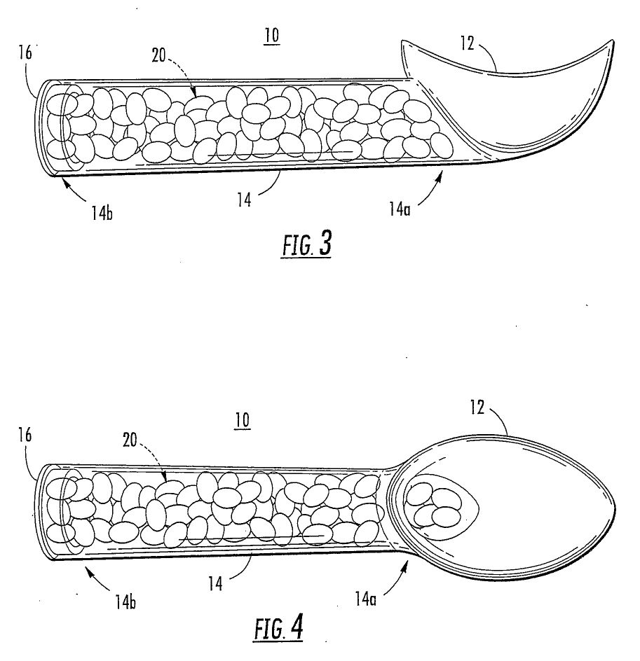

Aperture 18 in end cap 16 (FIGS. 2 and 5) has a diameter between approximately 2 millimeters to 10 millimeters, and may be larger or smaller depending on whether aperture 18 is to be used for filling or dispensing, or both filling and dispensing, candy 20. Although shown as a single round hole, aperture 18 may comprise a plurality of smaller holes or slots such as when used only for dispensing candy 20. A removable cover or plug 22 covers aperture 18, to prevent undesired spillage or contamination of candy 20 in handle 14. The plug may be made of rubber, for example, and may be hingedly attached or otherwise tethered to end cap 16 of handle 14. Alternatively, the plug may comprise a sliding or rotating member to block aperture 18 when aperture 18 is not in use. Still alternatively, end cap 16 may be on a side of handle 14, may be near bowl portion 12, or may be inside bowl portion 12, for example.

Examples of candy confections that may be used in conjunction with the dual function ice cream scoop of the present invention include, but are not limited to: M&M's® brand MINIS®, available from Mars Inc.; JOLLY RANCHER ROCKS®, available from Hershey Foods Corp.; and WONKA® brand NERDS®, available from Nestlé USA, Inc. However, it will be appreciated that any suitably small and clumping-resistant candy, or nuts, or other desired food item may be used with the invention.

Accordingly, the ice cream scoop 10 may be used to scoop a serving of frozen confection and then dispense candy 20 onto the frozen confection, such as by orienting the ice cream scoop such that aperture 18 is aimed downward, or by shaking or tapping scoop 10 to dispense candy 20. Handle 14 may be filled with candy 20 by removing end cap 16 and filling handle 14 at second end 14b, or by removing plug 22 from aperture 18 and filling handle 14 through aperture 18.

As will be appreciated by those skilled in the art, alternative embodiments of dual function ice cream scoops are contemplated without departing from the spirit and scope of the present invention. The alternative embodiments described herein are intended to be exemplary and are not limiting in any way. For example, a first alternative embodiment of a dual function ice cream scoop includes a handle portion, a bowl portion, and a separate candy storage and dispensing chamber for storing and dispensing candy through one or more apertures in a wall of the chamber. In a second alternative embodiment, a dual function ice cream scoop incorporates a candy storage and dispensing chamber that is internally illuminated, and which may include one or more batteries and a switch to supply electrical energy to a light. In a third alternative embodiment, a dual function ice cream scoop incorporates a candy storage and dispensing chamber that is at least partially opaque and has one or more translucent or transparent regions or zones through which an interior portion of the candy storage and dispensing chamber may be viewed. The transparent region or zone may distort light reflected by candy in the candy storage and dispensing chamber, such as to create a distorted, colored, or textured view of the candy. The opaque regions and the translucent or transparent regions may be arranged in a decorative pattern and may, for example, create an aesthetically-pleasing visual effect when the storage and dispensing chamber is at least partially filled with candy. For example, the storage and dispensing chamber may be a hollow cylindrical handle with a spiral pattern of white opaque regions alternating with colorless transparent regions that, when the storage and dispensing chamber is at least partly filled with colored candy, creates a “candy cane” visual effect.

In a fourth alternative embodiment, a dual function ice cream scoop incorporates a candy storage and dispensing chamber and an agitator or vibrating device to facilitate the dispensing of candy through one or more apertures in a wall of the storage and dispensing chamber, and may include one or more batteries and a switch to supply electrical energy to the agitator or vibrating device. In a fifth alternative embodiment, a dual function ice cream scoop incorporates a candy storage and dispensing chamber, and an ejector device that is similar to ejector or firing devices commonly used in conjunction with spring-loaded BB guns or pinball machines. A small portion of candy, such as an individual candy piece, is received in an ejection chamber, whereupon a spring-loaded member is drawn back and released to impact the candy piece and eject it through a barrel or tube in the candy storage and dispensing chamber, and out through an aperture in an outer wall of the candy storage and dispensing chamber. The loading and ejecting functions may be automated such that individual candy pieces may be sequentially ejected in rapid succession by depressing and holding a switch, for example.

These and other changes and modifications in the specifically described embodiments may be carried out without departing from the principles of the present invention, which is intended to be limited only by the scope of the appended claims as interpreted according to the principles of patent law.

1. An ice cream scoop comprising:
a scooping bowl;
a handle coupled with said scooping bowl; and
a topping retention enclosure defined on said scoop, said topping retention enclosure defining a substantially hollow section to receive a topping, at least one aperture adapted to provide the dispensing of the topping therethrough, and a cover adapted to selectively cover said aperture.

2. The ice cream scoop of claim 1, wherein said handle is substantially clear to permit viewing of the topping.

3. The ice cream scoop of claim 1, further comprising at least one viewing zone that is one of transparent and translucent to permit viewing of the topping.

4. The ice cream scoop of claim 1, wherein said aperture is between about 2 millimeters and about 10 millimeters in width.

5. The ice cream scoop of claim 1, wherein the topping comprises one of a candy confection and nuts.

6. An ice cream scoop comprising:
a scooping bowl; and
a handle defining a substantially hollow section to receive a topping, said handle having a first end, a second end, a gripping surface, at least one aperture adapted to permit dispensing of the topping therethrough, and a cover for covering said aperture, wherein said scooping bowl is connected at said first end of said handle.

7. The ice cream scoop of claim 6, wherein said handle is substantially clear to permit viewing of the topping.

8. The ice cream scoop of claim 6, further comprising at least one viewing zone that is one of transparent and translucent to permit viewing of the topping.

9. The ice cream scoop of claim 6, wherein said aperture is between about 2 millimeters and about 10 millimeters in width.

10. The ice cream scoop of claim 6, wherein the topping comprises one of a candy confection and nuts.

11. A method of serving a frozen confection, said method comprising:
providing an ice cream scoop having a confection retention enclosure defined on said scoop;
providing an aperture in said ice cream scoop, said aperture providing a passageway to said confection retention enclosure;
scooping a frozen confection into a portion with said scoop; and
dispensing a topping through said aperture and onto the frozen confection.

12. The method according to claim 11, further comprising:
providing a cover at said aperture; and
removing said cover prior to dispensing the topping through said aperture.

13. The method according to claim 12, further comprising replacing said cover at said aperture after dispensing the topping through said aperture.

14. The method according to claim 11, wherein the topping comprises one of a candy confection and nuts.
